(19) United States
(12) Patent Application Publication
(10) Pub. No.: US 2015/0269467 A1
(43) Pub. Date: Sep. 24, 2015

(54) RETRIEVING REMOTELY STORED INFORMATION

(71) Applicant: Exogal, LLC, Eagan, MN (US)

(72) Inventors: Jan Larsen, Hudson, WI (US); James Kinne, Alexandria, KY (US); Jeff Haagenstad, Eagan, MN (US); Larry Jacoby, Downing, WI (US)

(21) Appl. No.: 14/665,609

(22) Filed: Mar. 23, 2015

Related U.S. Application Data
(60) Provisional application No. 61/969,577, filed on Mar. 24, 2014.

(51) Int. Cl. G06K 19/06; H04L 29/08

(52) U.S. Cl. CPC G06K 19/06112; G06K 19/06037; H04L 67/02

(57) ABSTRACT

A method includes receiving a user command at an input of a product having a display, creating an image encoding information identifying remotely stored information corresponding to the product, and displaying the image on the display in a manner suitable for scanning by an independent device to extract the encoded information and obtain the remotely stored information from a remote server.

### RELATED APPLICATION

This application claims priority to U.S. Provisional Application Ser. No. 61/969,577 (entitled Retrieving Remotely Stored Information, filed Mar. 24, 2014) which is incorporated herein by reference.

### BACKGROUND

Many products, such as consumer products have displays to provide a limited amount of information useful to utilize the products. Such displays are limited in size and possibly resolution so as to be unsuitable for displaying more than the limited amount of information.

### SUMMARY

A method includes receiving a user command at an input of a product having a display, creating an image encoding information identifying remotely stored information corresponding to the product, and displaying the image on the display in a manner suitable for scanning by an independent device to extract the encoded information and obtain the remotely stored information from a remote server to be viewed on an external device such as a smart phone tablet or computer.

### BRIEF DESCRIPTION OF THE DRAWINGS

FIG. 1 is a representation of a display screen for a product showing product information according to an example embodiment.

FIG. 2 is a view of the display screen of FIG. 1 displaying a code according to an example embodiment.

FIG. 3 is a screen shot of a device operating in a scanning mode while scanning the display code of FIG. 2 according to an example embodiment.

FIG. 4 is a view of the display screen of FIG. 1 illustrating a list of manuals retrieved based on the scanned code of FIG. 3 according to an example embodiment.

FIG. 5 is a device displaying a manual identified via the scanned code of FIG. 3 according to an example embodiment.

FIG. 6 is a block schematic diagram of circuitry for implementing devices and to perform methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human actions, interactions, and implemented procedures in one embodiment. The software may consist of computer executable instructions stored on computer readable media or computer readable storage device such as one or more memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

Virtually all products whether consumer or professionally oriented are shipped from the manufacturer with a user manual. These manuals are generally printed on paper and have a number of inherent problems. The problems include but are not limited to customers losing manuals, which makes it difficult to look up information at a later date. Also, as the product is updated by the manufacturer, the manual must also be updated. Once a product ships from the factory, it is difficult to put the proper version of the manual into the user's hands. Still further, many products contain code that may be remotely updated, rendering a printed user manual inaccurate or incomplete.

When the user buys an upgrade, their original manual may also be out of date. Supporting foreign languages is also problematic. Some manufacturers deal with user language preferences by incorporating multiple languages in the manual. Others issue multiple copies of the manual each in a different language. In all cases each individual updates must be re-translated into each language. Physical manuals become inventory items and are very expensive to print driving up the business' operating expenses.

Various embodiments utilize a stored graphical image that contains encoded information to aid in obtaining remotely stored information such as a correct manual corresponding to the product. Other forms of remotely stored information may include support pages, or other information helpful in utilizing the product. In one embodiment, a bar code, such as a QR Code is incorporated into embedded software in a product. The QR code may be retrieved by a user command, also referred to as an operator command. The product may have a constrained display, such as a display that may be only a few inches in width or less. The display may also have a fairly low resolution that is not suitable for viewing and navigation through significant amounts of information. It is this not suitable for displaying a manual, but is suitable for displaying the QR code with sufficient resolution that it can be captured and decoded by an independent device with a display much better suited to reviewing significant amounts of information such as a user manual or other product supporting information.

When the QR code is displayed on the product display, the QR code may be scanned by a device such as a smart phone or tablet application which will invoke the device's web browser mechanism to retrieve a copy of the remotely stored information which may be keyed to the current version of the embedded software. The user manual may be in the form of a PDF document, images, or in any form suitable for display on the device. In one embodiment, the QR code may contain a URL corresponding to the product, and may also contain information identifying the product and version of programming installed on the product for use in obtaining the remotely stored information. A language setting from either the product as incorporated in the QR code, or a device browser language setting may be used to cause the proper version of the remotely stored information for the product and corresponding loaded software to be retrieved and displayed on the user's device.

A storyboard that shows the flow of a method of providing a user manual utilizing an image stored on the product is illustrated in the following figures. FIG. 1 is an example information display screen 100 on a product. In various embodiments, it may be a touchscreen, or in further embodiments, physical buttons may be provided adjacent displayed selectable functions. The position of such buttons may be such that they are clearly intended for the function selected, such as adjacent to each selection in row or column format such as many common automated teller devices, gasoline pumps, and other devices. The screen 100 in one embodiment includes information describing version information of the associated product, a user manual selection 110, and a support selection 120.

In a first scene of the storyline, a user may want to change a setting and wants to refer to the user manual. The user utilizes device information screen and selects the user manual option 110.

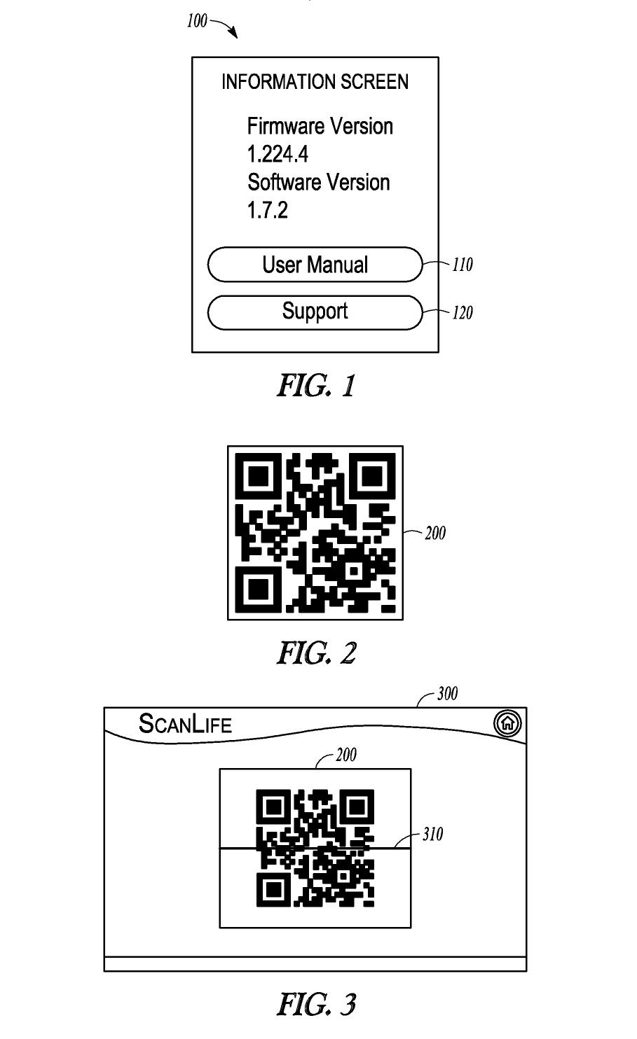

Computing circuitry, such as a microcontroller or microprocessor executes software that responds by putting a bar code, such as a QR Code on the screen as indicated at 200 in FIG. 2. The QR code 200 or other image may be displayed until a further selection is made by the user by tapping the screen or a button adjacent the screen, or for a limited period of time, such as 30 seconds. The limited period of time may vary, but should be sufficient to provide a user time to activate a scanning program on a hand held device and scan the code 200.

FIG. 3 is a screen shot of a user device 300 illustrating the device in a scanning mode and actively scanning the code 200 as indicated by a scan line 310. The user may then scan the QR Code using the device such as a smart phone or tablet application. The length of time the QR code is displayed may be a time suitable for allowing the initialization of a QR code reading app and scanning the code:

Once the scanner application recognizes the QR Code, it decodes the URL and opens a web browser. When a web browser requests a URL, it makes available to a web server based web site, a Language Identifier that the web server can use to return the web page directly in the user's default language. In one embodiment, the URL may be combined with the language Identifier to select the relevant user manual in the user's preferred language (Software Version 1.1, French Language).

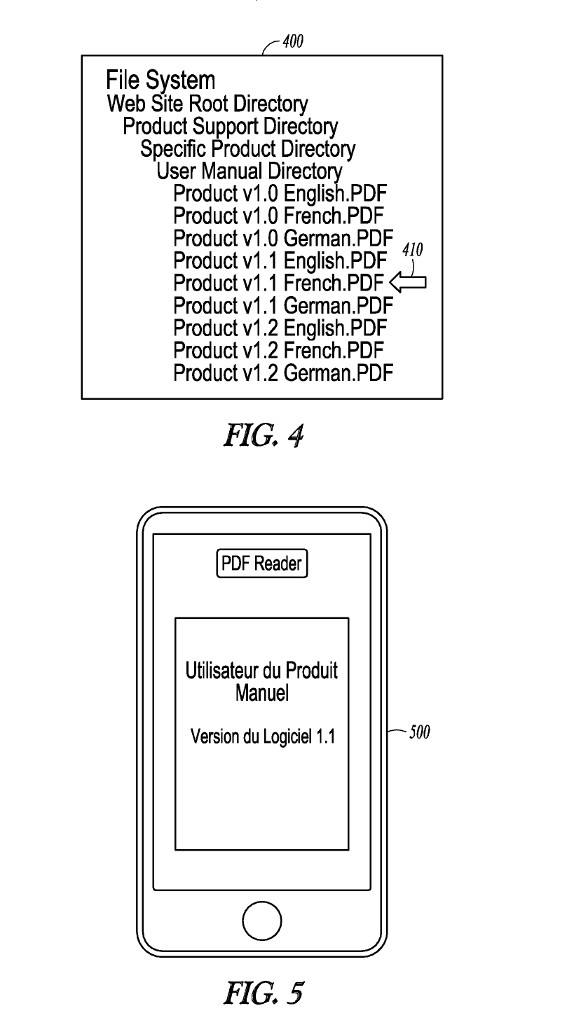

FIG. 4 is a screen shot 400 of a user device web browser illustrating a list of different product and version user manuals in different languages. When the user's preferred language is French, the screen 400 provides an indicator 410 on the list identifying the likely manual of interest based on the scanned code and user language preference. An arrow is used as the indicator 410 in one embodiment, but in further embodiments, the likely manual may be highlighted or otherwise noted to make it easy for a user to identify and select the manual via touchscreen or proximate button.

On selection of the manual from the list, or optionally directly based on the scanned code, the web server then sends back the proper PDF, or other type of document, and the device opens a PDF Reader application or other application compatible with a format of the returned user manual to render the User Manual as indicated at device 500 in FIG. 5.

The user can now navigate through the user manual and obtain the desired information.

In further embodiments, the QR Code could be replaced by other types of barcodes, other types of optical recognition systems such as Mobi or OCR. Software upgrades may be initiated by encoding the product and serial number into the QR Code and having a new update of software “pushed” to the device and updated automatically.

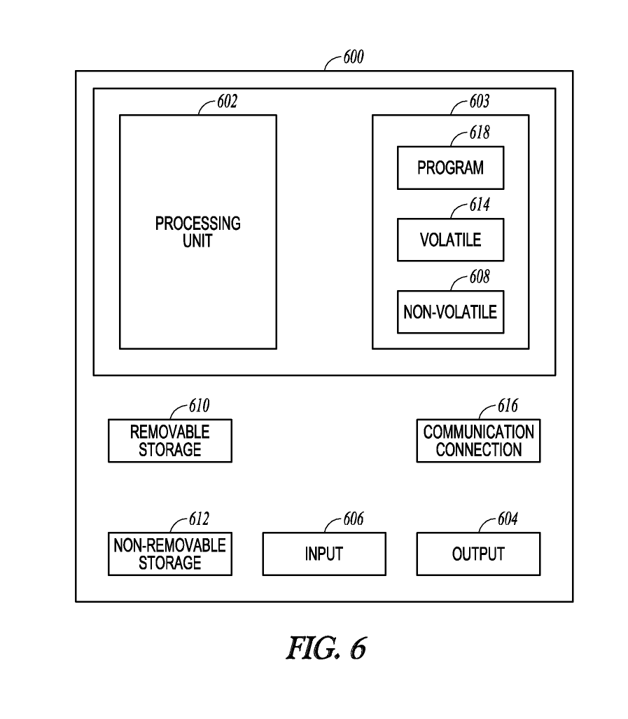

FIG. 6 is a block schematic diagram of a computer system 600 to implement one or both of a controller for the product and a device on which a product manual may be viewed, and a web server, according to example embodiments. When used as a controller, many of the components may not be needed.

One example computing device in the form of a computer 600, may include a processing unit 602, memory 603, removable storage 610, and non-removable storage 612. Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 600 may include or have access to a computing environment that includes input 606, output 604, and a communication connection 616. Input 606 and output 604 may be combined in the form of a touchscreen when computer 600 comprises a smart phone, touchpad or similar device. The computer may operate in a networked environment using a communication connection to connect to one or more remote computers, such as database servers and cellular networks. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 602 of the computer 600. A hard drive, CD-ROM, and RAM are some examples of articles including a non-transitory computer-readable medium. For example, a computer program 618 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 600 to provide generic access controls in a COM based computer network system having multiple users and servers.

### EXAMPLES

1. A method comprising:

receiving a user command at an input of a product having a display;

creating an image encoding information identifying remotely stored information corresponding to the product; and

displaying the image on the display in a manner suitable for scanning by an independent device to extract the encoded information and obtain the remotely stored information from a remote server.

2. The method of example 1 wherein the image comprises a QR code.

3. The method of any of examples 1-2 wherein the display is a constrained display and wherein the encoded information comprises a hyperlink.

4. The method of any of examples 1-3 wherein the encoded information includes a serial number of the product.

5. The method of any of examples 1-4 wherein the display comprises a display having a size and resolution not suitable for viewing significant amounts of information.

6. The method of any of examples 1-5 wherein the encoded information comprises an indication of a user language preference.

7. The method of any of examples 1-6 wherein the encoded information identifies a user manual corresponding to a specific software version stored on the product.

8. The method of any of examples 1-7 wherein the encoded information represents a software update to be pushed to the device.

9. The method of any of examples 1-8 and further comprising:

scanning the image using the independent device;

retrieving the remotely stored information; and

displaying the retrieved remotely stored information on a display of the independent device.

10. A machine readable storage device having instructions for execution by a processor of the machine to perform:

receiving a user command at an input of a product having a constrained display;

creating an image encoding information identifying remotely stored information corresponding to the product; and

displaying the image on the constrained display in a manner suitable for scanning by an independent device to extract the encoded information and obtain the remotely stored information from a remote server.

11. The machine readable storage device of example 10 wherein the image comprises a QR code.

12. The machine readable storage device of any of examples 10-11 wherein the encoded information comprises a hyperlink.

13. The machine readable storage device of any of examples 10-12 wherein the encoded information includes a serial number of the product.

14. The machine readable storage device of any of examples 10-13 wherein the constrained display comprises a display having a size and resolution not suitable for viewing significant amounts of information.

15. The machine readable storage device of any of examples 10-14 wherein the encoded information comprises an indication of a user language preference.

16. The machine readable storage device of any of examples 10-15 wherein the encoded information identifies a user manual corresponding to a software version stored on the product.

17. The machine readable storage device of any of examples 10-16 wherein the encoded information represents a software update to be pushed to the device.

18. A device comprising:

a processor;

a sensor supported by the device; and

a memory device coupled to the processor and having a program stored thereon for execution by the processor to:

receive a user command at an input of a product having a constrained display;

create an image encoding information identifying remotely stored information corresponding to the product; and

display the image on the constrained display in a manner suitable for scanning by an independent device to extract the encoded information and obtain the remotely stored information from a remote server.

19. The device of example 18 wherein the image comprises a QR code.

20. The device of any of examples 18-19 wherein the encoded information comprises a hyperlink.

21. The device of any of examples 18-20 wherein the encoded information includes a serial number of the product.

22. The device of any of examples 18-21 wherein the constrained display comprises a display having a size and resolution not suitable for viewing significant amounts of information.

23. The device of any of examples 18-22 wherein the encoded information comprises an indication of a user language preference.

24. The device of any of examples 18-23 wherein the encoded information identifies a user manual corresponding to a software version stored on the product.

25. The device of any of examples 18-24 wherein the encoded information represents a software update to be pushed to the device.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving a user command at an input of a product having a display;
creating an image encoding information identifying remotely stored information corresponding to the product; and
displaying the image on the display in a manner suitable for scanning by an independent device to extract the encoded information and obtain the remotely stored information from a remote server.

2. The method of claim 1 wherein the image comprises a QR code.

3. The method of claim 1 wherein the display is a constrained display and wherein the encoded information comprises a hyperlink.

4. The method of claim 1 wherein the encoded information includes a serial number of the product.

5. The method of claim 1 wherein the display comprises a display having a size and resolution not suitable for viewing significant amounts of information.

6. The method of claim 1 wherein the encoded information comprises an indication of a user language preference.

7. The method of claim 1 wherein the encoded information identifies a user manual corresponding to a specific software version stored on the product.

8. The method of claim 1 wherein the encoded information represents a software update to be pushed to the device.

9. The method of claim 1 and further comprising:
scanning the image using the independent device;
retrieving the remotely stored information; and
displaying the retrieved remotely stored information on a display of the independent device.

10. A machine readable storage device having instructions for execution by a processor of the machine to perform:
receiving a user command at an input of a product having a constrained display;
creating an image encoding information identifying remotely stored information corresponding to the product; and
displaying the image on the constrained display in a manner suitable for scanning by an independent device to extract the encoded information and obtain the remotely stored information from a remote server.

11. The machine readable storage device of claim 10 wherein the image comprises a QR code.

12. The machine readable storage device of claim 10 wherein the encoded information comprises a hyperlink.

13. The machine readable storage device of claim 10 wherein the encoded information includes a serial number of the product.

14. The machine readable storage device of claim 10 wherein the constrained display comprises a display having a size and resolution not suitable for viewing significant amounts of information.

15. The machine readable storage device of claim 10 wherein the encoded information comprises an indication of a user language preference.

16. The machine readable storage device of claim 10 wherein the encoded information identifies a user manual corresponding to a software version stored on the product.

17. The machine readable storage device of claim 10 wherein the encoded information represents a software update to be pushed to the device.

18. A device comprising:
a processor;
a sensor supported by the device; and
a memory device coupled to the processor and having a program stored thereon for execution by the processor to:
receive a user command at an input of a product having a constrained display;
create an image encoding information identifying remotely stored information corresponding to the product; and
display the image on the constrained display in a manner suitable for scanning by an independent device to extract the encoded information and obtain the remotely stored information from a remote server.

19. The device of claim 18 wherein the image comprises a QR code.

20. The device of claim 18 wherein the encoded information comprises a hyperlink.

21. The device of claim 18 wherein the encoded information includes a serial number of the product.

22. The device of claim 18 wherein the constrained display comprises a display having a size and resolution not suitable for viewing significant amounts of information.

23. The device of claim 18 wherein the encoded information comprises an indication of a user language preference.

24. The device of claim 18 wherein the encoded information identifies a user manual corresponding to a software version stored on the product.

25. The device of claim 18 wherein the encoded information represents a software update to be pushed to the device.
